(19) United States
(12) Patent Application Publication
(10) Pub. No.: US 2025/0180810 A1
(43) Pub. Date: Jun. 5, 2025

(54) VARIABLE OPTICAL ATTENUATOR AND VARIABLE OPTICAL ATTENUATION SYSTEM

(71) Applicants: OPTOQUEST CO., LTD., Saitama (JP); NATIONAL INSTITUTE OF INFORMATION AND COMMUNICATIONS TECHNOLOGY, Tokyo (JP)

(72) Inventors: Hideaki FURUKAWA, Tokyo (JP); Tetsuya KOBAYASHI, Saitama (JP); Masaru FUKUMITSU, Saitama (JP); Taketoshi TAKAHATA, Saitama (JP); Sayaka NAGAYAMA, Saitama (JP)

(73) Assignees: OPTOQUEST CO., LTD., Saitama (JP); NATIONAL INSTITUTE OF INFORMATION AND COMMUNICATIONS TECHNOLOGY, Tokyo (JP)

(21) Appl. No.: 18/843,267

(22) PCT Filed: Mar. 27, 2023
(86) PCT No.: PCT/JP2023/012177

§ 371 Date: Sep. 2, 2024

(30) Foreign Application Priority Data
Apr. 28, 2022 (JP) 2022-075142

(51) Int. Cl. G02B 6/26

(52) U.S. Cl. CPC G02B 6/262

(57) ABSTRACT

[Problem] To achieve, with a simple configuration, a variable optical attenuator that is capable of individually adjusting the amount of light that propagates through a plurality of cores. [Solution] A variable optical attenuator 10 which receives input of light that propagates through a first optical fiber 41 having a plurality of cores, which individually adjusts the amount of light that has propagated through each core, and which outputs the light to a second optical fiber 42 having a plurality of cores. The variable optical attenuator 10 comprises a separation optical system 11, 12 that spatially separates a plurality of light beams emitted into a space from the plurality of cores of the first optical fiber 41, and optical attenuation means 15 (a), 15 (b) that are capable of individually adjusting that attenuation amount of the plurality of light beams separated by the separation optical system 11, 12.

### TECHNICAL FIELD

The present invention relates to a variable optical attenuator and a variable optical attenuation system that are suitable for an optical fiber having a plurality of cores, such as a multi-core fiber (MCF). More specifically, the present invention relates to a variable optical attenuator and the like capable of individually adjusting the amount of propagation light of an optical beam emitted from each core of an MCF.

### BACKGROUND ART

In order to meet the demands of increasing traffic volume in optical fiber networks, space division multiplexing (SDM) techniques have been proposed, and as one of the techniques, multi-core fiber (MCF) has been proposed. As an MCF, a single optical fiber is known having a plurality of light-propagating cores. It is also known to use a fiber bundle that is made up of a plurality of single-mode fibers (SMF) each having a single core, as a substitute for an MCF.

For example, in optical transmission using MCF, loss differences between the cores when connecting connectors or fusion splicing and loss differences between the cores when light passes through the MCF accumulate, resulting in loss differences between the cores when light is transmitted over long distances. Further, in attempting to amplify the amount of light propagating through an MCF all at once using an MC-EDFA (optical amplifier), there is a concern that the amplification rate at each core will differ due to differences between amounts of light input to the cores, resulting in even greater differences between amounts of light propagating through the cores. Thus, a variable optical attenuator (VOA) is required to independently adjust the amount of light propagating through each core of an MCF.

It is now considered that the amount of light propagating through each core of an MCF can be individually adjusted using existing technology. In this case, a possible configuration is to couple the light from the cores of the MCF to a plurality of SMFs by using a branching device called a Fan-out device, individually adjust the amount of light for each optical path by using a variable optical attenuator provided in each SMF, and then re-couple the plurality of SMFs to the cores of the MCF by using a combining device called a Fan-in device (see Patent Literature 1).

### CITATION LIST

### Patent Literature

Patent Literature 1: Japanese Patent Application Publication No. 2006-195036

### SUMMARY OF INVENTION

### Technical Problem

However, in such a configuration using the Fan-out device and the Fan-in device, the need for such devices, which have physical waveguides, creates the problem of increased optical propagation loss due to losses within the devices and losses when connecting the MCF and the SMFs to each device. In addition, since it is necessary to mount a number of variable optical attenuators corresponding to the number of cores of the MCF, there are problems in that the entire device becomes complicated and large in size, and the manufacturing costs also increase.

Therefore, a main object of the present invention is to provide a variable optical attenuator with a simple configuration that can individually adjust the amount of light propagating through a plurality of cores.

### Solution to Problem

As a result of extensive research into means for solving the problems associated with the conventional technology, the inventor(s) of the present invention have discovered that a variable optical attenuator for MCF can be provided with a simple configuration in which light propagating through the cores of an MCF or the like is first emitted into space so as to be separated, and an optical attenuation means capable of individually adjusting the amount of light of each light beam is installed in the spatial optical system. Then, the inventor(s) conceived that the above-described problems would be solved based on this knowledge, and have made the present invention. Concretely describing, the present invention is configured as follows.

A first aspect of the present invention relates to a variable optical attenuator 10. The variable optical attenuator 10 according to the present invention is disposed between a first optical fiber 41 and a second optical fiber 42 when used. The first optical fiber 41 and the second optical fiber 42 are each an optical fiber having a plurality of cores, a representative example of which is a multi-core fiber (MCF). However, each of them is not limited to an MCF, and may be a bundle fiber in which a plurality of single mode fibers (SMFs) each having a single core are bundled, or a bundle fiber in which a plurality of MCFs are bundled. Further, the combination of the first optical fiber 41 and the second optical fiber 42 is not limited to a combination of MCFs or a combination of bundle fibers, but may be a combination of one being an MCF and the other being a bundle fiber. The variable optical attenuator 10 according to the present invention has a function of receiving light propagating through the first optical fiber 41, individually adjusting the amount of light that has propagated through each core, and outputting the light to the second optical fiber 42. Note that the “amount of light” is the total amount of energy of light passing through a certain surface within a certain period of time, and is also a physical quantity that represents the strength (optical power) of an optical signal propagating through an optical fiber.

The variable optical attenuator 10 includes a separation optical system and an optical attenuation means. The separation optical system spatially separates a plurality of light beams emitted into space from the plurality of cores of the first optical fiber 41. The separation optical system is composed of, for example, a plurality of lenses. The separation optical system is configured to separate the plurality of light beams in space and ultimately direct each light beam to its respective core of the second optical fiber 42. The optical attenuation means is configured to be able to individually adjust the attenuation amount of each of the light beams separated by the separation optical system. The optical attenuation means may be a type of attenuating a light beam by physically blocking a part of the light beam, or may be formed of a translucent material capable of adjusting the transmittance of the light beam.

With the above-described configuration, in the present invention, light propagating through each core of the MCF or the like is emitted into space, and each light beam is separated by the separation optical system. In addition, the optical attenuation means is provided in the separation optical system to individually adjust the amount of light of each light beam. This eliminates the need for connection devices such as a fan-out device and a fan-in device, thereby making it possible to reduce optical propagation loss. Furthermore, in the present invention, the amount of light of the light beam is adjusted in space, eliminating the need for an optical device (an individual variable optical attenuator) that adjusts the amount of light propagating through the core of an optical fiber. As a result, the entire device can be made simple and compact.

In the variable optical attenuator 10 according to the present invention, the optical attenuation means may include a plurality of light blocking elements 15 for blocking a plurality of light beams individually. In this case, each of the plurality of light blocking elements 15 is configured so that the amount of light beam to be blocked can be adjusted individually. For example, the light beam can be attenuated individually by blocking a part of the beam width of the light beam with a tip of the light blocking element 15. Further, the operation of the light blocking element 15 may be controlled by an actuator so that the amount of the beam width blocked by the light blocking element 15 can be adjusted. Thus, by using the light blocking element 15, the attenuation amount of the light beam can be adjusted with a simple configuration.

In the variable optical attenuator 10 according to the present invention, the light blocking element 15 (particularly its portion that comes into contact with the light beam) may be formed of an opaque material that does not transmit the light beam. Further, the light blocking element 15 may be formed of an optical member capable of deflecting the direction of the light beam to cut off a part of the light beam from the optical path. Thus, by the light blocking element 15 being formed of an opaque material or a deflecting member, the attenuation amount of the light beam can be adjusted with a simple configuration.

In the variable optical attenuator 10 according to the present invention, the optical attenuation means may include a liquid crystal element 19 capable of individually adjusting the transmittance of each of the light beams. The liquid crystal element 19 allows the transmittance of a transmission area for each light beam to be adjusted individually, so that the attenuation amount of the light beam can be adjusted with a compact configuration.

In the variable optical attenuator 10 according to the present invention, the separation optical system may include a first lens 11, a second lens 12, a third lens 13, and a fourth lens 14. The first lens 11 receives the light beams from the cores of the first optical fiber 41 and makes angular differences between the optical paths of the light beams to increase their separation width. The second lens 12 receives the light beams that have passed through the first lens 11 and arranges the optical paths of the light beams to be substantially parallel. The third lens 13 receives the light beams that have passed through the second lens 12 and reduces the separation width of the optical paths of the light beams. The fourth lens 14 receives the light beams that have passed through the third lens 13 and couples the optical paths of the light beams to their respective cores of the second optical fiber 42. In this case, the optical attenuation means is preferably provided between the second lens 12 and the third lens 13. Thus, by the separation optical system being configured with the plurality of lenses, the propagation loss of each light beam can be reduced.

In the variable optical attenuator 10 according to the present invention, the separation optical system may include a first lens (FIG. 3: first lens 11), a second lens (FIG. 3: fifth lens 16), a reflective element 17, and a third lens (FIG. 3: fourth lens 14). The first lens (11) receives the light beams from the cores of the first optical fiber 41 and makes angular differences between the optical paths of the light beams to increase their separation width. The second lens (16) receives the light beams that have passed through the first lens (11) and condenses the light beams toward the reflective element 17 in the subsequent stage. The reflective element 17 reflects the light beams condensed by the second lens (16). The third lens (14) receives the light beams that have been reflected by the reflective element 17 and passed through the second lens (16) again, and couples the optical paths of the light beams to their respective cores of the second optical fiber 42. In this case, it is preferably provided between the second lens (16) and the reflective element 17. Thus, the variable optical attenuator 10 can be made compact as a whole by using the reflective element 17. Further, the optical paths of the light beams can be folded back by using the reflective element 17, and therefore, for example, the first optical fiber 41 and the second optical fiber 42 can be arranged next to and coupled to each other.

In the variable optical attenuator 10 according to the present invention, the reflective element 17 may transmit a part of each light beam. An example of such a reflective element 17 is a half mirror. In this case, preferably, the variable optical attenuator 10 further includes light detection means for detecting the amount of light of a part of each light beam that has been transmitted through the reflective element 17. In this case, the attenuation amount of each beam by the optical attenuation means is adjusted individually in accordance with the amount of light detected by the light detection means. Thus, the variable optical attenuator 10 can be controlled with a simple configuration by using some of the light that has been transmitted through the reflective element 17 as monitor light.

A second aspect of the present invention is a variable optical attenuation system 100. The variable optical attenuation system 100 according to the present invention includes a variable optical attenuator 10 and a control device 30. The variable optical attenuator 10 is according to the first aspect, and has the configuration as described above. The control device 30 detects the amount of light propagating through each core of a second optical fiber 42, and controls an optical attenuation means in accordance with the detected amount of light to individually adjust the attenuation amount of each beam by the optical attenuation means.

### Advantageous Effects of Invention

According to the present invention, it is possible to provide a variable optical attenuator with a simple configuration that can individually adjust the amount of light propagating through a plurality of cores.

### BRIEF DESCRIPTION OF DRAWINGS

FIG. 1 schematically illustrates one embodiment of a variable optical attenuation system.

FIG. 2 schematically illustrates a first embodiment of a variable optical attenuator.

FIG. 3 schematically illustrates a second embodiment of a variable optical attenuator.

FIG. 4 schematically illustrates a third embodiment of a variable optical attenuator.

### DESCRIPTION OF EMBODIMENTS

Embodiments of the present invention will be described below with reference to the drawings. The present invention is not limited to the embodiments described below, and includes any modifications of the following embodiments as appropriate in the scope obvious to those skilled in the art.

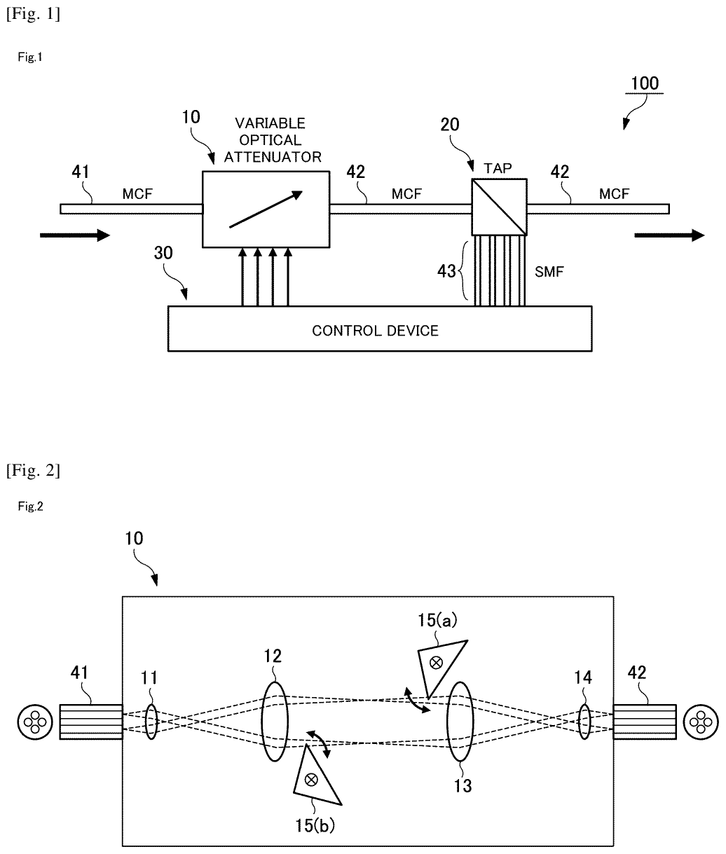

FIG. 1 illustrates the overall configuration of a variable optical attenuation system 100. The variable optical attenuation system 100 mainly attenuates light propagating through a first optical fiber 41 having a plurality of cores individually and couples the light to a second optical fiber 42 also having a plurality of cores. In the present embodiment, the first and second optical fibers 41 and 42 are each a multi-core fiber (MCF).

As illustrated in FIG. 1, the variable optical attenuation system 100 includes a variable optical attenuator 10, a tap 20, and a control device 30. The variable optical attenuator 10 is the kernel of this system and has a function of individually attenuating the light propagating through each core of the first optical fiber 41. The variable optical attenuator 10 will be described in detail later. The tap 20 (also referred to as an optical coupler) branches a part of an amount of light propagating through each core of the second optical fiber 42 into a single mode fiber (SMF) 43. For example, the number of SMFs 43 provided is the same as the number of cores of the second optical fiber 42; for example, if the second optical fiber 42 has four cores, four SMFs 43 are also provided. The SMFs 43 are each connected to the control device 30. The control device 30 feedback-controls the variable optical attenuator 10 based on the amount of light propagating through each SMF 43. Specifically, the control device 30 includes, but not illustrated, a photodetector that detects the amount of light branched into each SMF 43, and a computation device (such as a PC) that estimates the amount of light propagating through each core of the second optical fiber 42 from the detected amount of light and sends a control signal to the variable optical attenuator 10 based on the estimated value. The tap 20 and the control device 30 to be used may be of known configuration.

Next, the configuration of the variable optical attenuator 10 will be described in detail. FIG. 2 illustrates a first embodiment of the variable optical attenuator 10. As illustrated in FIG. 2, the variable optical attenuator 10 according to the present embodiment includes a plurality of lenses 11 to 14 and a plurality of light blocking elements 15. In the present embodiment, each of the first optical fiber 41 and the second optical fiber 42 will be described as an MCF having four cores by way of example. However, the number of cores of the first and second optical fibers 41 and 42 is not limited to four, and may be, for example, two, five, six, or seven cores.

An output end of the first optical fiber 41 is connected to an input end of the variable optical attenuator 10. The inside of the variable optical attenuator 10 is hollow, and therefore the light propagating through each core of the first optical fiber 41 is emitted into the variable optical attenuator 10 from the output end of the first optical fiber 41. As used herein, such light propagating through space is referred to as a “light beam”. The light beam from each core of the first optical fiber 41 is emitted into the variable optical attenuator 10 while diffusing so that its beam diameter increases.

The plurality of light beams emitted from the first optical fiber 41 into the variable optical attenuator 10 all enter the first lens 11. The first lens 11 is a collimator lens having a front focal position at the output end of the first optical fiber 41. Accordingly, if a light beam enters on the optical axis of the first lens 11, the light beam is collimated (parallelized) and travels straight along the optical axis of the first lens 11. However, as in the example illustrated in FIG. 2, when a light beam enters at a position offset from the optical axis of the first lens 11, the light beam is collimated and travels straight with an angular difference relative to the optical axis of the first lens 11. Therefore, the light beams emitted from the cores of the first optical fiber 41 pass through the first lens 11, intersect at the rear focal position of the first lens 11, and then are gradually separated spatially. This results in an increased separation width of the light beams. Thus, the first lens 11 has a function of collimating a plurality of light beams and a function of increasing the separation width.

The second lens 12 is provided in the stage subsequent to the first lens 11. The second lens 12 is a condenser lens, and the front focal position of the second lens 12 is aligned with the rear focal position of the first lens 11 (i.e., the intersection point of the light beams). Accordingly, the plurality of light beams that have passed through the first lens 11 are sufficiently separated and then enter the second lens 12, where they are condensed and diffused while being aligned substantially in parallel by the second lens 12. Specifically, as illustrated in FIG. 2, each light beam that has passed through the second lens 12 is condensed so that its beam diameter gradually decreases, converges at the rear focal position of the second lens 12, then travels through space while diffusing so that the beam diameter increases again, and enters the third lens 13. At this time, in the space between the second lens 12 and the third lens 13, the optical axes of the light beams are substantially parallel to each other.

Further, as the second lens 12, a condenser lens having a longer focal length than the first lens 11 is used. Specifically, the spacing between the light beams between the second lens 12 and the third lens 13 can be changed using a magnification between the focal lengths of the first lens 11 (collimator lens) and the second lens 12 (condenser lens). For example, in a case where a condenser lens having a focal length ten times that of the first lens 11 is used as the second lens 12, the spacing between the light beams between the second lens 12 and the third lens 13 can be increased to ten times the spacing between the cores of the first optical fiber 41. From the viewpoint of ensuring sufficient spacing between the light beams, the second lens 12 preferably has a focal length that is at least two times, at least five times, or at least ten times that of the first lens 11.

As illustrated in FIG. 2, the combination of the third lens 13 and the fourth lens 14 is arranged at a position such that the combination of the first lens 11 and the second lens 12 is linearly symmetrical with a line connecting the focal points (convergence points) of the light beams as an axis of symmetry. As a result, the first to fourth lenses 11 to 14 form a relay optical system that couples the first optical fiber 41 and the second optical fiber 42 together.

More specifically, the third lens 13 is provided in the stage subsequent to the second lens 12. The third lens 13 is a collimator lens, and the front focal position of the third lens 13 is aligned with the rear focal position of the second lens 12 (i.e., the convergence points of the light beams). As illustrated in the example of FIG. 2, when a light beam that has passed through the second lens 12 enters at a position offset from the optical axis of the third lens 13, the light beam is collimated and travels straight with an angular difference relative to the optical axis of the third lens 13. As a result, the plurality of light beams that have passed through the third lens 13 intersect at the rear focal position of the third lens 13 while their separation width gradually decreasing and then are spatially separated again. This reduces the separation width of the light beams. Thus, the third lens 13 has a function of collimating the plurality of light beams and a function of reducing the separation width.

The fourth lens 14 is provided in the stage subsequent to the third lens 13. The fourth lens 14 is a condenser lens, and the front focal position of the fourth lens 14 is aligned with the rear focal position of the third lens 13 (i.e., the intersection point of the light beams). The rear focal position of the fourth lens 14 is aligned with an input end of the second optical fiber 42. Thereby, as illustrated in FIG. 2, the light beams passing through the fourth lens 14 are condensed onto their respective cores of the second optical fiber 42 while being aligned substantially in parallel by the fourth lens 14. At this time, in the space between the fourth lens 14 and the second optical fiber 42, the optical axes of the light beams are substantially parallel to each other. Thus, the first to fourth lenses 11 to 14 form a spatial optical system that optically couples the first optical fiber 41 and the second optical fiber 42.

As illustrated in FIG. 2, the light blocking elements 15 are disposed on their respective optical paths of the plurality of light beams between the second lens 12 and the third lens 13. The number of light blocking elements 15 provided is the same as the number of light beams propagating through the space of the variable optical attenuator 10, that is, the number of cores of each of the first and second optical fibers 41 and 42. In FIG. 2, two light blocking elements 15 (a) and (b) are depicted, but actually, four light blocking elements 15 are provided because the first and second optical fibers 41 and 42 each have four cores.

The light blocking element 15 is configured to be able to individually block a light beam and to individually adjust the amount of light beam to be blocked. Thus, the light blocking element 15 is used for the purpose of attenuating the amount of light of the light beam by blocking a part of the light beam. Specifically, the light blocking element 15 is configured to be able to block only a part of the beam width of the light beam and to adjust the beam width to be blocked. This allows each light blocking element 15 to adjust the attenuation amount of each of the light beams individually. Note that in the present invention, it is not assumed that the light beam will be completely blocked by the light blocking element 15, but depending on the application, the light blocking element 15 may be possible to completely block the light beam.

As described above, the light blocking element 15 blocks a part of the beam width, and therefore the light blocking element 15 is preferably provided at a position in the optical path of the light beam where its beam width is as wide as possible. Specifically, as illustrated in FIG. 2, the focal point of each light beam is located at the midpoint between the second lens 12 and the third lens 13, and the beam width of the light beam is smallest at that focal point. On the other hand, the closer to the second lens 12 and the third lens 13 the beam width of each light beam is, the larger it is. Therefore, it is preferable to provide each light blocking element 15 at a position closer to the second lens 12 or the third lens 13 than to the focal point of each beam. For example, preferably, half of the plurality of light blocking elements 15 (four light blocking elements 15 in the example illustrated in FIG. 2) is provided closer to the second lens 12 and the remaining half is closer to the third lens 13.

The light blocking element 15 has a tip portion that comes into contact with the light beam and is formed with an acute cross-sectional angle, allowing fine adjustment of the amount of light beam to be blocked. The light blocking element 15, at least its tip portion, is preferably made of an opaque or light reflective material so as to be able to block a part of the light beam. The light blocking element 15 made of an opaque material absorbs the light beam, thereby preventing the light beam from passing through. The opaque material to be used may have a transmittance of, for example, 0 to 10% or 0 to 5% for the light beam. Further, the light blocking element 15 made of a light reflective material deflects the direction of the light beam, thereby cutting off a part of the light beam from the optical path. The polarization direction of the light beam is preferably adjusted so as not to interfere with other light beams.

Further, as illustrated in FIG. 2, the light blocking element 15 is provided with an actuator, and the amount of light beam to be blocked is changed by operating the light blocking element 15 with this actuator. However, if the light blocking element 15 is inserted perpendicular to the optical axis of the light beam, the amount of light beam is rapidly attenuated, making it difficult to finely adjust the attenuation amount. Therefore, the light blocking element 15 is preferably inserted obliquely with respect to the optical axis of the light beam. From this viewpoint, in the present embodiment, as the actuator to operate the light blocking element 15, a rotational motion mechanism for rotating the light blocking element 15 is adopted, rather than a linear motion mechanism. Accordingly, as illustrated in FIG. 2, the tip portion of the light blocking element 15 is inserted obliquely with respect to the optical axis of the light beam. A typical example of such a rotary motion mechanism is a motor. Further, the operation of the actuator of the light blocking elements 15 is individually controlled by a control signal from the control device 30 (see FIG. 1) described above. Thus, by providing the light blocking elements 15 having individually controllable actuators in the optical paths of a plurality of light beams, respectively, the amount of light beam to be blocked (attenuated) can be individually adjusted.

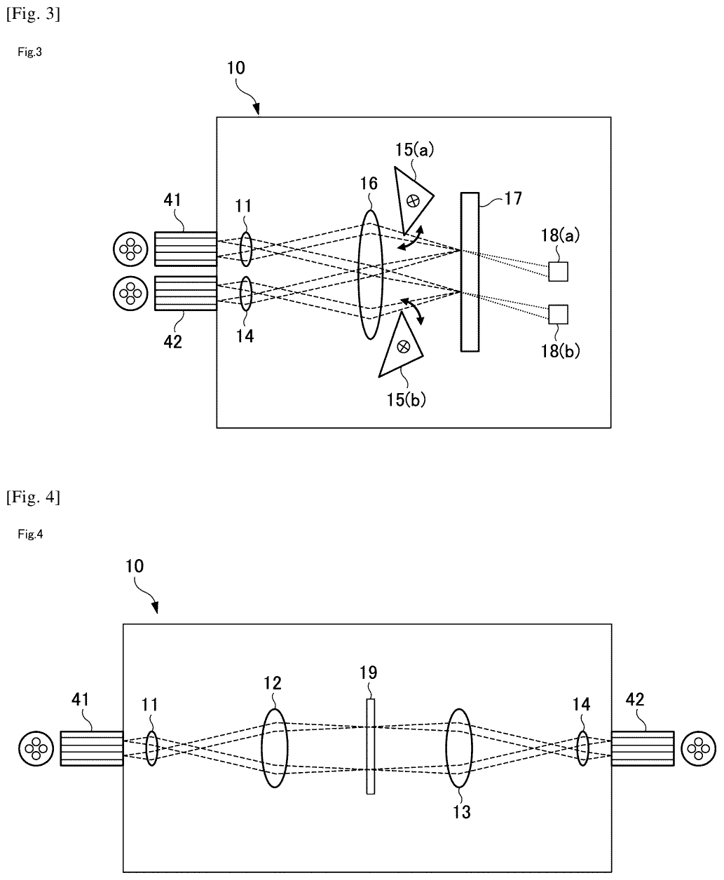

Next, a second embodiment of the variable optical attenuator 10 according to the present invention will be described with reference to FIG. 3. The second embodiment will be described focusing on the differences from the first embodiment described above, and the same components as those in the first embodiment will be denoted by the same reference numerals and description thereof will be omitted.

In the second embodiment illustrated in FIG. 3, the functions of the second lens 12 and the third lens 13 in the first embodiment illustrated in FIG. 2 are replaced by a fifth lens 16 and a reflective element 17. Specifically, in the second embodiment, in order to implement the functions of the second lens 12 and the third lens 13 (see FIG. 2) by the single fifth lens 16 (see FIG. 3), the reflective element 17 is disposed at the focuses (convergence points) of the light beams.

More specifically, the light beams emitted from the cores of the first optical fiber 41 pass through the first lens 11, whereupon they are collimated by the first lens 11 and enter the fifth lens 16 with the spacing between the light beams being increased. The light beams are aligned in parallel and condensed by the fifth lens 16. Therefore, in this aspect, the fifth lens 16 functions as a condenser lens, as with the second lens 12 illustrated in FIG. 2. The reflective element 17 is disposed at the rear focal position of the fifth lens 16. Therefore, the light beams that have passed through the fifth lens 16 are condensed on the surface of the reflective element 17, reflected by the surface of the reflective element 17, and enter the fifth lens 16 again. When entering the fifth lens 16 again, the light beams are collimated by the fifth lens 16 and enter the fourth lens 14 with the spacing between the light beams being reduced. Therefore, in this side, the fifth lens 16 functions as a collimator lens, as with the third lens 13 illustrated in FIG. 2. The light beams are condensed by the fourth lens 14 again and directed to the lenses of the second optical fiber 42.

Further, in the second embodiment, as in the first embodiment, light blocking elements 15 are provided on the optical paths of the plurality of light beams, respectively. The light blocking elements 15 are provided between the fifth lens 16 and the reflective element 17. As illustrated in FIG. 3, the light blocking elements 15 may be provided on the optical paths (outward paths) of the light beams between where they pass through the fifth lens 16 and where they reach the reflective element 17, or on the optical paths (return paths) of the light beams between they are reflected by the reflective element 17 and where they enter the fifth lens 16 again. Thus, the second embodiment can also achieve the same optical functions as the first embodiment.

The reflective element 17 may be a type of reflecting the entire amount of the light beams, or may be a so-called half mirror that reflects some amounts of the light beams and transmits the remainder. In a case where a half mirror is used as the reflective element 17, some light beams that have transmitted through the reflective element 17 may be detected by light receiving elements 18 as illustrated in FIG. 3. The number of light receiving elements 18 arranged is the same as the number of light beams. In the example illustrated in FIG. 3, only two light receiving elements 18 (a) and (b) are depicted, but actually, four light receiving elements 18 are provided corresponding to the four light beams. The light receiving element 18 to be used may be a general photodiode (PD) that converts an amount or intensity of light into an electrical signal. The electrical signals detected by the light receiving elements 18 are transmitted to the control device 30 (see FIG. 1) and used to individually control the operation of the light blocking elements 15. Note that in a case where the light receiving elements 18 are built in the variable optical attenuator 10 as illustrated in FIG. 3, the tap 20 and the single mode fiber 43 illustrated in FIG. 1 may be eliminated.

Next, a third embodiment of the variable optical attenuator 10 according to the present invention will be described with reference to FIG. 4. The third embodiment will also be described focusing on the differences from the first embodiment described above, and the same components as those in the first embodiment will be denoted by the same reference numerals and description thereof will be omitted.

In the third embodiment illustrated in FIG. 3, the functions of the plurality of light blocking elements 15 in the first embodiment illustrated in FIG. 2 are replaced by a single liquid crystal element 19. Specifically, in the third embodiment, the liquid crystal element 19 is provided at a position where all light beams pass through, and the transmittance of the liquid crystal element 19 is controlled for each transmission area of the light beams, thereby individually adjusting the attenuation amount of each light beam.

Note that the liquid crystal element 19 may be a general type capable of controlling the light transmittance for each area. Specifically, in the liquid crystal element 19, a liquid crystal layer in which glass substrates with transparent electrodes are arranged on both sides is disposed between two polarizing plates with different polarization directions. When a voltage is applied between the electrodes, the orientation of liquid crystal molecules in the liquid crystal layer between the electrodes changes. This makes it possible to adjust the light transmittance by combining the movement of the liquid crystal molecules and the polarization directions of the two polarizing plates. As illustrated in FIG. 3, the liquid crystal element 19 is preferably disposed at the focal points of the light beams, that is, at the rear focal position of the second lens 12. However, it is also possible to dispose the liquid crystal element 19 at a position closer to the second lens 12 or the third lens 13 than to the focal points of the beams.

Thus, the liquid crystal element 19 can be used as an optical attenuation means for individually adjusting the amounts of attenuation of a plurality of light beams. In the present embodiment, since it is not necessary to dispose a light blocking element 15 for each light beam, the entire configuration of the variable optical attenuator 10 can be made compact.

As described above, in the present specification, the embodiments of the present invention have been described with reference to the drawings in order to express the contents of the present invention. However, the present invention is not limited to the above-described embodiments, but includes modifications and improvements obvious to those skilled in the art based on the matters described in the present specification.

### REFERENCE SIGNS LIST

10 Variable optical attenuator
11 First lens
12 Second lens
13 Third lens
14 Fourth Lens
15 Light blocking element (optical attenuation means)
16 Fifth Lens
17 Reflective element
18 Light receiving element (light detection means)
19 Liquid crystal element (optical attenuation means)
20 Tap
30 Control device
41 First optical fiber
42 Second optical fiber
43 Single mode fiber
100 Variable optical attenuation system

1. A variable optical attenuator for receiving light propagating through a first optical fiber having a plurality of cores, adjusting an amount of light propagating through each core individually, and outputting the light to a second optical fiber having a plurality of cores, the variable optical attenuator comprising:
a separation optical system that spatially separates a plurality of light beams emitted into space from the plurality of cores; and
optical attenuation means capable of individually adjusting attenuation amounts of the plurality of light beams separated by the separation optical system.

2. The variable optical attenuator according to claim 1, wherein
the optical attenuation means includes a plurality of light blocking elements that individually block the plurality of light beams, and
each of the plurality of light blocking elements is configured to be able to individually adjust an amount of the light beam to be blocked.

3. The variable optical attenuator according to claim 2, wherein the light blocking element is formed of an opaque material that does not transmit the light beam.

4. The variable optical attenuator according to claim 2, wherein the light blocking element is formed of an optical member capable of deflecting a direction of the light beam to cut off a part of the light beam from an optical path.

5. The variable optical attenuator according to claim 1, wherein the optical attenuation means includes a liquid crystal element capable of individually adjusting transmittances of the plurality of light beams.

6. The variable optical attenuator according to claim 1, wherein
the separation optical system includes:
a first lens that receives the respective light beams from the respective cores of the first optical fiber and makes angular differences between the optical paths of the respective light beams to increase a separation width;
a second lens that receives the respective light beams that have passed through the first lens, and arranges optical paths of the respective light beams to be substantially parallel,
a third lens that receives the respective light beams that have passed through the second lens, and reduces a separation width of optical paths of the respective light beams; and
a fourth lens that receives the respective light beams that have passed through the third lens, and couples optical paths of the respective light beams to the respective cores of the second optical fiber, wherein
the optical attenuation means is provided between the second lens and the third lens.

7. The variable optical attenuator according to claim 1, wherein
the separation optical system includes:
a first lens that receives the respective light beams from the respective cores of the first optical fiber and makes angular differences between the optical paths of the respective light beams to increase a separation width;
a second lens that receives the respective light beams that have passed through the first lens, and condenses the respective light beams toward a reflective element in subsequent stage;
the reflective element that reflects the respective light beams condensed by the second lens; and
a third lens that receives the respective light beams that have been reflected by the reflective element and passed through the second lens again, and couples optical paths of the respective light beams to the respective cores of the second optical fiber, wherein
the optical attenuation means is provided between the second lens and the reflective element.

8. The variable optical attenuator according to claim 7, wherein
the reflective element is a type of transmitting a part of each light beam, and
the variable optical attenuator further comprises light detection means for detecting an amount of light of the part of each light beam that has been transmitted through the reflective element, and
the attenuation amount of each beam by the optical attenuation means is individually adjusted in accordance with the amount of light detected by the light detection means.

9. A variable optical attenuation system comprising:
the variable optical attenuator according to claim 1; and
a control device that detects an amount of light propagating through each core of the second optical fiber, and controls the optical attenuation means in accordance with the detected amount of light to individually adjust the attenuation amount of each beam by the optical attenuation means.
